(19) United States
(12) Patent Application Publication
(10) Pub. No.: US 2025/0299469 A1
(43) Pub. Date: Sep. 25, 2025

(54) INFORMATION PROCESSING DEVICE

(71) Applicant: TOYOTA JIDOSHA KABUSHIKI KAISHA, Toyota-shi Aichi-ken (JP)

(72) Inventors: Jun HATTORI, Toyota-shi Aichi-ken (JP); Hirofumi MORISHITA, Toyota-shi Aichi-ken (JP); Toshiyuki ISHIHARA, Hino-shi Tokyo (JP)

(73) Assignee: TOYOTA JIDOSHA KABUSHIKI KAISHA, Toyota-shi Aichi-ken (JP)

(21) Appl. No.: 19/068,369

(22) Filed: Mar. 3, 2025

(30) Foreign Application Priority Data
Mar. 25, 2024 (JP) 2024-048487

(51) Int. Cl. G06V 10/62; G06Q 10/0639; G06V 20/52; G06V 40/10

(52) U.S. Cl. CPC G06V 10/62; G06Q 10/06398; G06V 20/52; G06V 40/10

(57) ABSTRACT

An information processing device includes: an acquisition unit configured to acquire a plurality of temporal pickup images of a work object that moves on a conveyance path; and a control unit configured to derive a work time of a worker from the pickup images, and to output information indicating the work time of the worker, the work time of the worker being a time during which the worker is included in a work zone around the work object while the work object is at a reference position on the conveyance path.

### CROSS-REFERENCE TO RELATED APPLICATION

This application claims priority to Japanese Patent Application No. 2024-048487 filed on Mar. 25, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

In the assembly, repair or fix of a vehicle or the like, a work object is moved between work processes in a flow work by a conveyance path such as a conveyor belt, and a worker assigned for each work process performs a work corresponding to the work process, to the work object. Various technologies for assisting the management of the work of the worker have been proposed. For example, Japanese Unexamined Patent Application Publication No. 2021-125183 (JP 2021-125183 A) discloses a disclosure for determining the start and end of the work of the worker.

### SUMMARY

There is room for the improvement in the management efficiency for the work of the worker.

An information processing device and others that make it possible to improve the management efficiency for the work of the worker in the flow work will be disclosed below.

An information processing device in the present disclosure includes: an acquisition unit configured to acquire a plurality of temporal pickup images of a work object that moves on a conveyance path; and a control unit configured to derive a work time of a worker from the pickup images, and to output information indicating the work time of the worker, the work time of the worker being a time during which the worker is included in a work zone around the work object while the work object is at a reference position on the conveyance path.

The information processing device and others in the present disclosure make it possible to improve the management efficiency for the work of the worker in the flow work.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an exemplary configuration of a management system;

FIG. 2 is a flowchart showing an exemplary operation procedure of an information processing device;

FIG. 3A is a diagram showing an exemplary pickup image;

FIG. 3B is a diagram showing an exemplary pickup image; and

FIG. 4 is a diagram showing an exemplary display of work time information.

### DETAILED DESCRIPTION OF EMBODIMENTS

Embodiments will be described below.

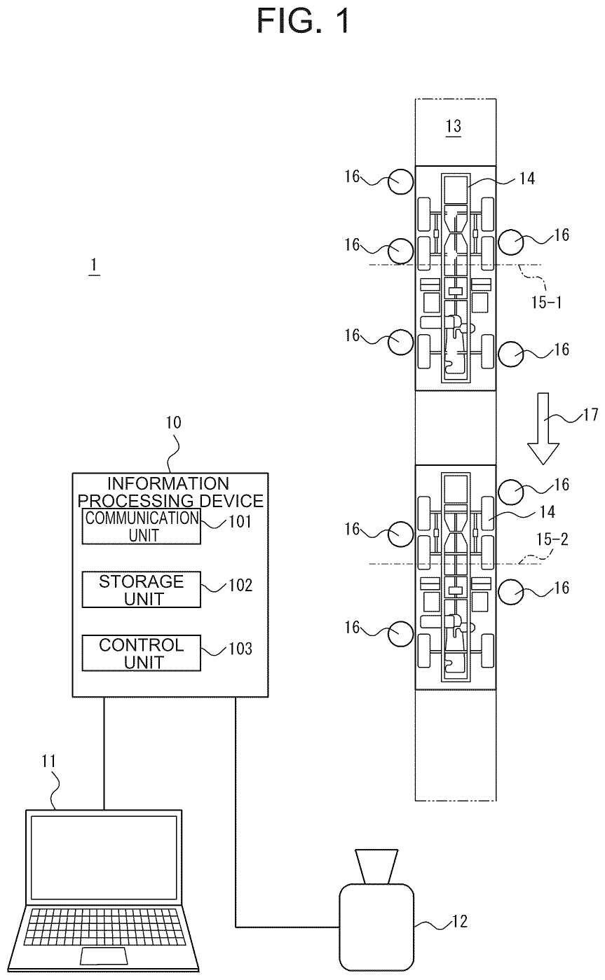

FIG. 1 is a diagram showing an exemplary configuration of a management system for a flow work that includes an information processing device in an embodiment. A management system 1 is a system that assists the management of works of workers 16 for one or more work objects 14 that move on a conveyance path 13 in a factory shown as a schematic planar view. On the conveyance path 13, a plurality of reference positions 15 (hereinafter, shown as 15-1, 15-2 with branch numbers, when two exemplified reference positions are distinguished) corresponding to processes in the flow work are set, and the work objects 14 sequentially move on the conveyance path 13 along a movement direction 17 shown by an arrow, and pass through the reference positions 15-1, 15-2. When the work object 14 moves to the reference position 15, one or more workers 16 perform predetermined works corresponding to processes, to the work object 14. For example, the conveyance path 13 includes a conveyance mechanism such as a conveyor belt. For example, the work object 14 is a body, a chassis, or the like of a vehicle. The works that are performed by the workers 16 are the assembly, connection and others of various components. The management system 1 includes one or more information processing devices 10, one or more terminal devices 11, and one or more pickup devices 12 that are connected by a wired or wireless network such as an in-factory local area network (LAN), so as to be capable of communicating information with each other. The pickup device 12 is installed at a position where the pickup device 12 can pick up the work object 14 that moves on the conveyance path 13 and the reference position 15 (one of the reference positions 15-1, 15-2). The information processing device 10 sends information for the management of the work of the worker 16, to the terminal device 11, based on a pickup image sent from the pickup device 12. The terminal device 11 outputs information sent from the information processing device 10, to present the information to an operator, and thereby, the operator can know the state of the work of the worker 16.

The information processing device 10 includes a communication unit 101 as an “acquisition unit” that acquires a plurality of temporal pickup images of the work object 14 that moves on the conveyance path 13, and a control unit 103 that derives a work time during which the worker 16 is included in a work zone around the work object 14 while the work object 14 is at the reference position 15 on the conveyance path 13, from the pickup images, and that outputs information (hereinafter, referred to as work time information) indicating the work time of the worker 16. A state where a part including an end portion of the work zone is superimposed on the reference position 15 corresponds to the state where the work object 14 is at the reference position 15. In the embodiment, the terminal device 11 receives the work time information output by the information processing device 10, and the terminal device 11 outputs the work time information. Thereby, for example, the operator can know the respective work times of the workers 16, and can sensitively manage the work for each worker 16. Consequently, it is possible to improve the management efficiency for the work of the worker in the flow work.

Next, the configurations of the information processing device 10, the terminal device 11, and the pickup device 12 will be described.

The information processing device 10 includes the communication unit 101, a storage unit 102, and the control unit 103. For example, the information processing device 10 is constituted by one or more personal computers. In the case where the information processing device 10 is configured to include a plurality of devices that can communicate with each other, the communication unit 101, the storage unit 102, and the control unit 103 are appropriately disposed in the devices.

The communication unit 101 includes one or more interfaces for wired or wireless communication. For example, the interface for communication is a LAN interface, an interface for an exclusive line, or the like. The communication unit 101 receives information that is used for the operation of the information processing device 10, and sends information that is obtained by the operation of the information processing device 10. The information processing device 10 communicates information with the terminal device 11 and the pickup device 12 through the communication unit 101.

For example, the storage unit 102 includes a main storage device, an auxiliary storage device, one or more semiconductor memories that function as a cache memory, one or more magnetic memories, one or more optical memories, or combinations of at least two kinds of them. For example, the semiconductor memory is a random access memory (RAM) or a read only memory (ROM). For example, the RAM is a static RAM (SRAM) or a dynamic RAM (DRAM). For example, the ROM is an electrically erasable programmable ROM (EEPROM). The storage unit 102 stores information that is used for the operation of the information processing device 10 and information that is obtained by the operation of the information processing device 10.

The control unit 103 includes one or more processors, one or more dedicated circuits, or combinations of them. For example, the processor is a general-purpose processor such as central processing unit (CPU), or a dedicated processor for a particular process, as exemplified by a graphics processing unit (GPU). For example, the dedicated circuit is a field-programmable gate array (FPGA), an application specific integrated circuit (ASIC), or the like. The control unit 103 executes information processing related to the operation of the information processing device 10, while controlling parts of the information processing device 10.

The function of the information processing device 10 is realized by the execution of a control program by the processor included in the control unit 103. The control program is a program for causing a computer to execute a process in a step included in the operation of the information processing device 10 and thereby causing the computer to realize a function corresponding to the process in the step. That is, the control program is a program for causing the computer to function as the information processing device 10. Further, some or all of the functions of the information processing device 10 may be realized by the dedicated circuit included in the control unit 103. Further, the control program may be stored in a non-transitory recording/storing medium that can be read by the information processing device 10, and may be read from the medium by the information processing device 10.

For example, the terminal device 11 is a personal computer. The terminal device 11 includes constituents equivalent to the communication unit 101, storage unit 102 and control unit 103 of the information processing device 10, and includes an input interface that accepts information input by operator's operation, and an output interface that outputs a variety of information to the operator, as exemplified by a display and a speaker.

The pickup device 12 includes a camera that picks up an image by visible light, and control and communication circuits for the camera. For example, the camera temporally picks up pickup images at several tens of frames per second, and sends the temporal pickup images to the information processing device 10. For example, the camera includes a wide-angle lens, and is installed so as to view the work object 14 and the reference position 15 on the conveyance path 13 from above.

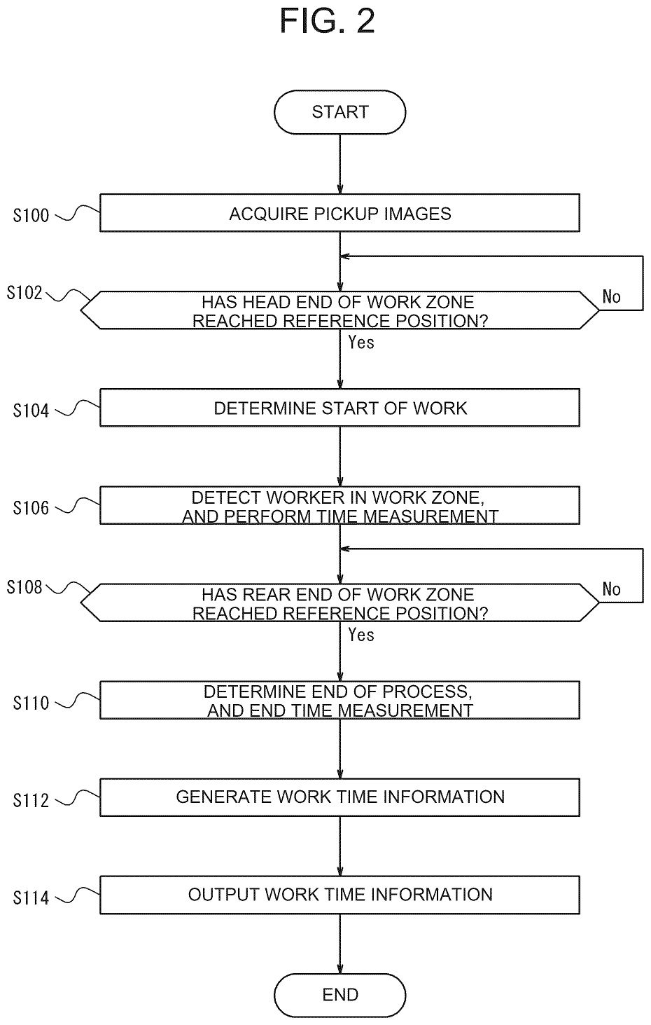

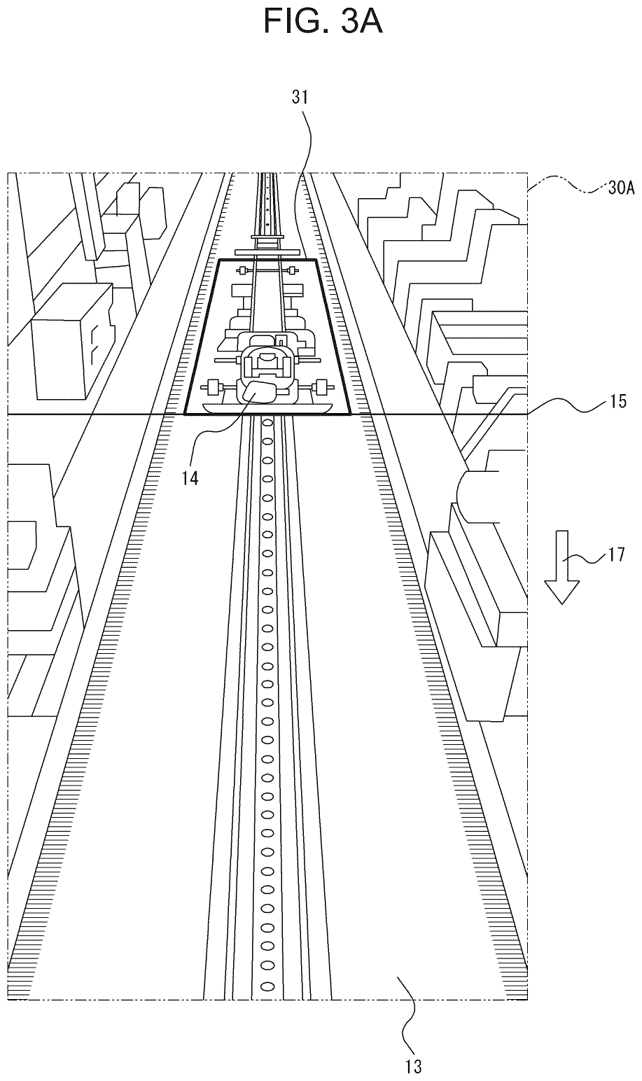

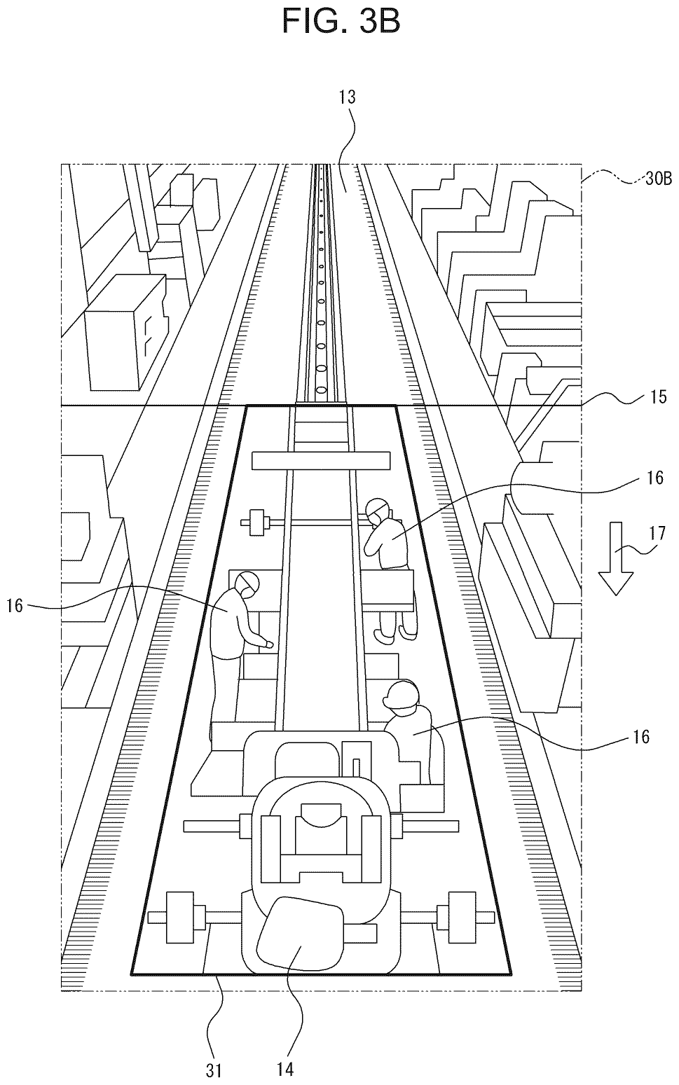

The operation of the information processing device 10 will be described with use of FIG. 2, FIG. 3A, and FIG. 3B. FIG. 2 is a flowchart showing an exemplary operation procedure of the information processing device. Each step in FIG. 2 is executed by the control unit 103. The procedure in FIG. 2 is executed with an arbitrary period, for example, with a period of several tens of microseconds to several seconds, when the conveyance path 13 is operating. FIG. 3A and FIG. 3B show examples of the temporal pickup images picked up by the pickup device 12.

In step S100 in FIG. 2, the control unit 103 acquires temporal pickup images from the pickup device 12. For example, the control unit 103 acquires pickup images by an arbitrary frame number of two or more.

In step S102, the control unit 103 determines whether a head end of the work zone has reached the reference position. The control unit 103 performs an arbitrary image recognition process to the temporal pickup images, to detect the work object 14, and demarcates the work zone that includes the work object 14. Further, the control unit 103 demarcates the reference position 15 on the pickup image, based on information that indicates the positional relation between the pickup device 12 and the conveyance path 13 and that is previously stored in the storage unit 102. A target indicating the reference position 15 may be previously provided on the conveyance path 13, and the control unit 103 may detect the target, to demarcate the reference position 15. Furthermore, the control unit 103 detects the movement of the work object 14 based on the change in the position of the work object 14 on the temporal pickup images, to determine whether the head end of the work zone has reached the reference position. For example, when the work object 14 that moves on the conveyance path 13 along the movement direction 17 is detected as shown in a pickup image 30A in FIG. 3A, the work zone 31 that includes the work object 14 is demarcated. In the case where the worker 16 is position on the inside of the work zone 31, the work zone 31 is a roughly rectangular zone that includes a range having dimensions in which the worker 16 is likely to perform the work to the work object 14, for example, a range of several tens of centimeters to 200 centimeters around the work object 14. The control unit 103 derives dimensions of the work object 14 detected from the pickup image, using information such as the distance from the pickup device 12 to the conveyance path 13 and the angular field of the pickup device 12, and demarcates the work zone 31 for the work object 14 in the pickup image 30A. Then, it is determined whether the head end of the work zone 31, that is, an end portion of the work zone 31 on the movement direction 17 side has reached the reference position 15. In the case where the work zone 31 has reached the reference position 15 (Yes), the control unit 103 proceeds to step S104, and determines the start of the work process at the reference position 15. On the other hand, in the case where the work zone 31 has not reached the reference position 15 (No), the control unit 103 continues the determination in step S102.

In step S106, the control unit 103 detects the worker 16 in the work zone 31, and performs time measurement. The control unit 103 detects the worker 16 positioned in the work zone 31, by detecting a feature image that indicates the worker 16. For example, the feature image is a helmet that is worn by the worker 16. In the case where a plurality of workers 16 performs works in one work process, each worker 16 previously wears a helmet having a different color that does not overlap with those of the other workers 16. Thereby, the control unit 103 can detect and identify each worker 16, by adopting the helmet and the color of the helmet as the feature image. Note that, for example, the feature image may be a unique character or sign on a work cloth. Moreover, the control unit 103 measures a time during which each worker 16 is positioned in the work zone 31. The time measured in this way corresponds to the work time of each worker 16. Note that, in the case where the worker 16 is not positioned in the work zone 31, the control unit 103 does not perform the time measurement for each worker 16.

In step S108, the control unit 103 determines whether a rear end of the work zone 31 has reached the reference position 15. In step S108, in the case where the rear end of the work zone 31, that is, a side of the work object 14 in the opposite direction of the movement direction 17 has reached the reference position 15 as shown in a pickup image 30B in FIG. 3B (Yes), the control unit 103 proceeds to step S110, and in the case where the rear end of the work zone 31 has not reached the reference position 15 (No), the control unit 103 executes step S106 and step S108 again. In a processing cycle that is repeatedly executed, the work time that is measured when step S106 is executed is accumulated for each worker 16, and is stored in the storage unit 102.

In step S110, the control unit 103 determines the end of work process at the reference position 15, and ends the time measurement started in step S106 for each worker 16.

In step S112, the control unit 103 generates the work time information indicating the work time of the worker 16. The work time information includes the accumulated work time in the work process at the reference position 15 for each worker 16.

In step S114, the control unit 103 outputs the work time information. For example, the control unit 103 sends the work time information to the terminal device 11. Thereby, the terminal device 11 can present the work time information to the operator, for example, by displaying.

The information processing device 10 executes the procedure in FIG. 2 for respective work processes corresponding to the reference positions 15, and thereby, can derive the work time of each worker 16 for each work process. For a plurality of work processes, the control unit 103 may generates the work time information that includes the work time of each worker 16 for each work process.

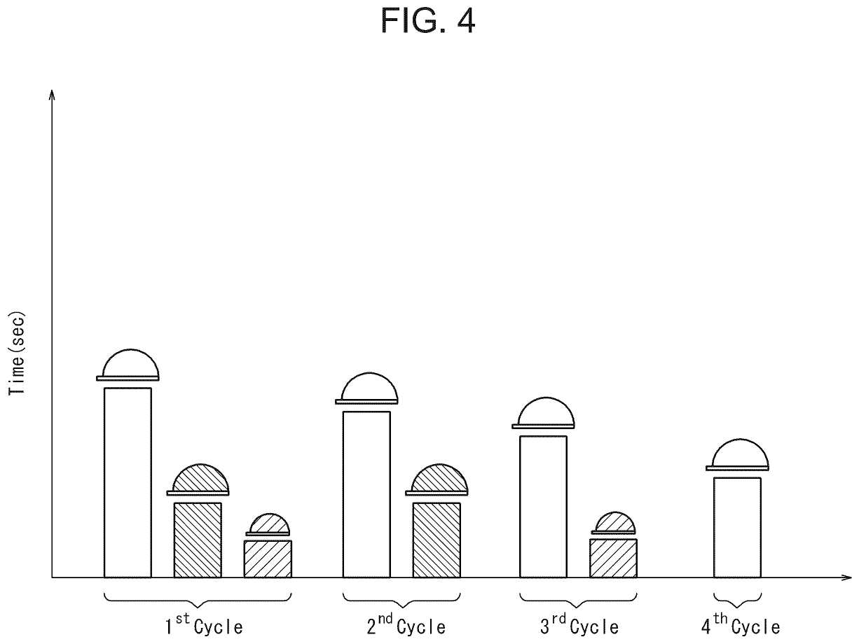

FIG. 4 shows an example of the work time information that is displayed by the terminal device 11. The ordinate axis indicates the work time, and the abscissa axis indicates work processes and workers 16 in each work process. Accumulated values of work times of workers 16 in each of work processes “1st Cycle”, “2nd Cycle”, “3rd Cycle”, and “4th Cycle” are shown by graphs with different hatchings. By this presentation of the work time information, the operator can know the respective work times of the workers 16, and can sensitively manage the work for each worker 16. Consequently, it is possible to improve the management efficiency for the work of the worker in the flow work. Note that, the display manner of the work time information shown in FIG. 4 is an example, and the work time information may be displayed by another kind of graph, a table, or the like.

The above-described control unit 103 is previously configured so as to be capable of recognizing the shape of the work object 14, recognizing that the head end of the work zone 31 has reached the reference position 15, recognizing that the rear end of the work zone 31 has reached the reference position 15, and detecting the worker 16 in the work zone 31, for example, by machine learning with use of a mathematical model such as a convolutional neural network (CNN) or a recurrent neural network (RNN).

As a modification, in step S106, the control unit 103 may detect a temporal action pattern of the worker 16, for example, a pattern of the action of the hand, from the temporal pickup images, and may measure the work time, further, on condition that the action pattern of the worker 16 coincides with a pattern having a high probability that the work is being performed. The action pattern having a high probability that the work is being performed is previously specified and is stored in the storage unit 102, and the control unit 103 checks the action pattern, so that it is possible to determine that the work is being performed. Alternatively, the control unit 103 may determine that the work is being performed, using a model that determines that the work is being performed based on the action pattern and is generated by machine learning. Thereby, it is possible to more accurately measure the work time.

The above-described embodiment allows the operator to know the state of the work of the worker 16, and makes it possible to improve the management efficiency for the work of the worker in the flow work.

The embodiment has been described above based on the drawings and examples. Note that a person skilled in the art can perform various modifications and alterations based on the present disclosure. Accordingly, it is noted that the modifications and the alterations are included in the scope of the present disclosure. For example, functions and others included in elements, steps and others can be reallocated such that there is no logical inconsistency, and a plurality of elements, steps and others can be combined to one, or can be divided.

What is claimed is:

1. An information processing device comprising:
an acquisition unit configured to acquire a plurality of temporal pickup images of a work object that moves on a conveyance path; and
a control unit configured to derive a work time of a worker from the pickup images, and to output information indicating the work time of the worker, the work time of the worker being a time during which the worker is included in a work zone around the work object while the work object is at a reference position on the conveyance path.

2. The information processing device according to claim 1, wherein the work time is a time during which the control unit detects a feature image in the work zone, from the pickup images, the feature image indicating the worker.

3. The information processing device according to claim 1, wherein the control unit determines that the work object is at the reference position, when the work zone is superimposed on the reference position.

4. The information processing device according to claim 1, wherein the control unit derives the work time for each of a plurality of the workers, and outputs information indicating the work time for each of the workers.

5. The information processing device according to claim 1, wherein the control unit derives the work time, on condition that a predetermined action pattern of the worker is detected from the pickup images.
